(19) United States
(12) Patent Application Publication
(10) Pub. No.: US 2023/0220868 A1
(43) Pub. Date: Jul. 13, 2023

(54) SCREW NUT

(71) Applicant: REVOTEC ZT GMBH, Wien (AT)

(72) Inventors: Michael REITERER, Wien (AT); Gergely GULYAS, Wien (AT)

(73) Assignee: REVOTEC ZT GMBH, Wien (AT)

(21) Appl. No.: 17/630,961

(22) PCT Filed: Aug. 4, 2020
(86) PCT No.: PCT/AT2020/060288

§ 371 Date: Jan. 28, 2022

(30) Foreign Application Priority Data
Aug. 4, 2019 (AT) A60182/2019

(51) Int. Cl. F16B 31/02; F16B 37/00

(52) U.S. Cl. CPC F16B 31/028; F16B 37/00

(57) ABSTRACT

The present invention relates to a screw nut equipped with sensors (2, 3) on its lateral surfaces.

### CROSS-REFERENCE TO RELATED APPLICATION(S)

This application is the National Stage of International Patent Application No. PCT/AT2020/060288 filed on Aug. 4, 2020, which claims priority from Austrian Patent Application No. A60182/2019 filed on Aug. 4, 2019, both of which are herein incorporated by reference in their entireties.

### SUMMARY

The invention relates to an intelligent screw nut which, on the lateral surfaces, is equipped with sensors in the direction of the screw axis and/or sensors transverse to the screw axis. As an alternative to the intelligent screw nut, the sensors can also be fixed to the lateral surfaces of an ordinary screw (on the screw head). Additionally, an RFID transponder (also called RFID tag) and/or a micro-controller is/are attached to the lateral surfaces of the intelligent screw nut. The RFID transponders are preferably designed as passive RFID tags that do not require their own power supply.

With the intelligent nut, it is possible to check the magnitude of the preload force in the threaded bolt or in a screw on which the intelligent nut is screwed.

The invention relates to an intelligent screw nut which is screwed onto a threaded rod or to an intelligent screw itself having the features of the preamble of the independent patent claim.

In the prior art, screw nuts are conventionally used in combination with a screw or a threaded bolt to connect two or more elements. When the screw or nut is tightened, compression of the screw nut occurs, and this compression is determined directly on the screw nut by measurement using the present invention.

The invention relates to an intelligent screw nut which, on the lateral surfaces, is equipped with sensors in the direction of the screw axis and sensors transverse to the screw axis. Preferably, the sensor types used are strain gauges, but other sensor types can also be fixed to the screw nut. Preferably, passive sensors that do not require their own power supply are fixed to the lateral surfaces of the screw nuts. The strain gauges are fixed to the lateral surfaces with an adhesive or by means of a welded joint. Fixation is preferably centric, i.e. at half the height and half the width of the screw nut's lateral surface. In addition, an RFID transponder or a micro-controller is fixed to the lateral surfaces. The sensors are connected to the RFID transponder or to the micro-controller by means of sensor lines.

When the intelligent screw nut is tightened, material compression of the nut occurs and the magnitude of this compression is measured by the sensors. A functional mathematical relationship exists between the magnitude of the compression and the preload force in the threaded bolt or screw, and the measured value of the compression is converted into an equivalent preload force. Using an RFID reader or via a cable connection, the current magnitude of the screw nut's compression/the preload force in the threaded bolt or in the screw is read.

The invention makes it possible to determine/check all constructions in which fasteners are designed with screw nuts by measuring the magnitude of the current preload force in the threaded bolt or in the screw. Therefore, we are dealing with a radical innovation.

Optionally, an intelligent screw nut is provided, wherein the screw nut is equipped with sensors on the lateral surfaces of the screw nut.

Optionally, it is provided that the screw nut is equipped with an RFID transponder or with a micro-controller.

Optionally, it is provided that the fixed sensors are oriented in the direction of the screw axis and transversely to the screw axis.

Optionally, it is provided that the RFID transponder or the micro-controller is connected to the sensors by means of a sensor cable.

Optionally, it is provided that the RFID transponder or the micro-controller is fixed to any and/or to multiple lateral surface(s) of the intelligent screw nut.

Optionally, it is provided that the sensor measurement signals are transmitted from one lateral surface to any other lateral surface of the screw nut by means of sensor cables.

Optionally, it is provided that the sensor measurement signals are transmitted from one lateral surface to any other lateral surface of the screw nut by means of radio technology.

Optionally, it is provided that the sensors are glued or welded to the lateral surface.

Optionally, it is provided that strain gauges are preferably fixed to the lateral surfaces as sensors that measure the compression of the intelligent screw nut.

Optionally, it is provided that the RFID transponder comprises an analog-to-digital converter and an amplifier.

Optionally, it is provided that the RFID transponder is a passive RFID transponder.

Optionally, it is provided that the screw nut additionally comprises a temperature sensor.

Optionally, it is provided that the temperature sensor is designed to measure the temperature of the screw nut.

Optionally, it is provided that the RFID transponder or the micro-controller is designed to wirelessly transmit measurement signals of the sensors to a receiver.

Further features of the invention become apparent from the following description, the figures and the claims. Further, features and embodiments are disclosed which are described in the Austrian patent application A 60182/2019 of 4 Aug. 2019, which gives rise to a priority right.

The invention relates to a fastener/fastening means. In particular, the fastening means may be a screw nut or a screw. Typically, a screw nut has a screw direction/screwing direction, along which the screw nut can be screwed on threads of a threaded bolt or the like. Likewise, a screw typically has a screw direction/screwing direction, along which the screw can be screwed or inserted into internal threads, a clearance or into another object or element.

When the fastener is tightened, forces occur in the screw direction/screwing direction, among other things. These forces consist in particular in a tensile stress along the screw direction/screwing direction. In the context of the present invention, it was found that the tensile stress simultaneously causes a compression of a part of the fastener. It was found that this compression is proportional to the tensile stress and can therefore be used to determine the tensile stress.

In particular, the compression can be determined by strain gauge sensors whose direction of measurement is arranged substantially parallel to the screwing direction/screw direction. Strain gauge sensors can in particular be strain gauges, but any other devices for measuring a strain or compression, such as fiber Bragg grating sensors, may be used.

Preferably, multiple sensors with the same direction of measurement are arranged on the fastener. This allows variations in the measured values to be compensated for by forming an average value.

The readout of the measured values is preferably wireless, in particular via an RFID transponder or a micro-controller. The RFID transponder can be an RFID sensor transponder. The RFID transponder can be a passive RFID transponder. The RFID transponder may comprise an analog-to-digital converter and an amplifier. Alternatively, the readout of the measured values can be wired via a cable connection.

A passive RFID transponder with an analog-to-digital converter and an amplifier offers the advantage that no power supply is required at the fastener. The energy required to read out a measured value can be provided by a reader, for example. This minimizes possible technical problems due to a lack of power supply. In addition, the fastener can be used in locations that do not offer a continuous power supply.

Optionally, a temperature sensor can be provided in addition to the strain gauge sensor to measure the material temperature of the fastener. Measurement errors that could result from temperature-related strain or compression of the fastener can thus be compensated for. In particular, the measured value of the strain gauge sensor can be corrected by the factor of the temperature-related strain/compression of the fastener. The temperature-related strain/compression of the fastener depends on material parameters, such as the coefficient of expansion. These material parameters can be determined empirically by a person skilled in the art.

If the fastener comprises multiple sensors, these can be connected to one another via a sensor wire or via multiple sensor wires. This allows the measured values of multiple sensors to be read out via a transmitter, for example an RFID transponder. The signal transmission between multiple sensors can also be wireless, for example by means of a radio device.

The technical features of selected embodiments are described below. Any combinations of two, three or more of the described embodiments are also disclosed herein.

Embodiment 1. A fastener, wherein at least one sensor is arranged on the fastener.

Embodiment 2. The fastener according to embodiment 1, wherein the fastener is a screw nut.

Embodiment 3. The fastener according to embodiment 2, wherein the sensor is arranged on a lateral surface of the screw nut.

Embodiment 4. The fastener according to embodiment 1, wherein the fastener is a screw.

Embodiment 5. The fastener according to embodiment 4, wherein the sensor is arranged on a lateral surface of the screw, in particular on a lateral surface of the head of the screw.

Embodiment 6. The fastener according to one of the embodiments 1 to 6, wherein the sensor is a strain gauge sensor.

Embodiment 7. The fastener according to embodiment 6, wherein the sensor is a strain gauge.

Embodiment 8. The fastener according to embodiment 6 or 7, wherein the strain gauge sensor has a direction of measurement.

Embodiment 9. The fastener according to embodiment 8, wherein the strain gauge has a direction of measurement.

Embodiment 10. The fastener according to one of the embodiments 1 to 9, wherein the fastener has a screwing axis or a screw axis.

Embodiment 11. The fastener according to embodiment 10, wherein the sensor, in particular the direction of measurement of the sensor, is arranged substantially parallel to the screwing axis and/or to the screw axis.

Embodiment 12. The fastener according to embodiment 10, wherein the sensor, in particular the direction of measurement of the sensor, is arranged substantially orthogonally to the screwing axis and/or to the screw axis.

Embodiment 13. The fastener according to one of the embodiments 1 to 12, wherein multiple sensors are provided.

Embodiment 14. The fastener according to embodiment 13, wherein at least one first sensor, in particular the direction of measurement of at least one first sensor, is arranged substantially parallel to the screwing axis and/or to the screw axis, and wherein at least one second sensor, in particular the direction of measurement of at least one second sensor, is arranged substantially orthogonally to the screwing axis and/or to the screw axis.

Embodiment 15. The fastener according to one of the embodiments 1 to 14, wherein one transponder element is provided.

Embodiment 16. The fastener according to embodiment 15, wherein the transponder element is designed to transmit measurement data of at least one sensor wirelessly and/or without contact.

Embodiment 17. The fastener according to embodiment 15 or 16, wherein the transponder element is an RFID transponder, an RFID sensor transponder or a micro-controller.

Embodiment 18. The fastener according to embodiment 17, wherein the transponder element is an RFID transponder which comprises an analog-to-digital converter and an amplifier.

Embodiment 19. The fastener according to one of the embodiments 1 to 18, wherein multiple sensors are connected to one another via a sensor cable.

Embodiment 20. The fastener according to one of the embodiments 1 to 19, wherein at least one sensor is a passive sensor.

Embodiment 21. A fastener, wherein the fastener is a screw nut or a screw, wherein at least one sensor is arranged on the fastener, wherein the sensor is configured as a strain gauge sensor, in particular a strain gauge, wherein the sensor is arranged on a lateral surface of the screw nut or on a lateral surface of the screw, in particular on a lateral surface of the head of the screw, wherein one transponder element is provided, wherein the transponder element is an RFID transponder, an RFID sensor transponder or a micro-controller.

Embodiment 22. The fastener according to embodiment 21, wherein the transponder element is designed to transmit measurement data of at least one sensor wirelessly and/or without contact.

Embodiment 23. The fastener according to embodiment 21 or 22, wherein the transponder element is an RFID transponder which comprises an analog-to-digital converter and an amplifier.

Embodiment 24. The fastener according to one of the embodiments 21 to 23, wherein the sensor, in particular the direction of measurement of the sensor, is arranged substantially parallel to the screwing axis of the nut and/or to the screw axis.

Embodiment 25. The fastener according to one of embodiments 1 to 24, wherein at least two sensors are provided, wherein a first sensor is designed as a strain gauge sensor and wherein a second sensor is designed as a temperature sensor.

Embodiment 26. The fastener according to embodiment 25, wherein the sensor, in particular the direction of measurement of the sensor, is arranged substantially parallel to the screwing axis and/or to the screw axis.

Embodiment 27. A fastener, wherein the fastener is a screw nut or a screw, wherein at least one sensor is arranged on the fastener, wherein the sensor is configured as a strain gauge sensor, wherein the sensor is arranged on a lateral surface of the screw nut or on a lateral surface of the screw, in particular on a lateral surface of the head of the screw, wherein one transponder element is provided and wherein a temperature sensor is provided.

Embodiment 28. The fastener according to embodiment 27, wherein the transponder element is an RFID transponder, an RFID sensor transponder or a micro-controller, in particular a passive RFID transponder.

Embodiment 29. The fastener according to embodiment 27 or 28, wherein the temperature sensor is designed to measure the material temperature of the fastener.

Embodiment 30. The fastener according to one of the embodiments 27 to 29, wherein the transponder element is designed to transmit the measurement data of the strain gauge sensor and the temperature sensor.

In the following, the present invention is explained in detail on the basis of illustrating examples.

### BRIEF DESCRIPTION OF THE DRAWINGS

FIGS. 1 to 4 show schematic views of an inventive screw nut according to a first example in different projection views;

FIGS. 5 and 6 show schematic views of an inventive screw nut according to a second example;

FIG. 7 shows a schematic perspective view of an inventive screw nut according to a third example;

FIGS. 8 and 9 show schematic views of an inventive screw nut according to a fourth example in different projection views;

FIG. 10 shows a schematic top view of an inventive screw nut according to a fifth example.

### DETAILED DESCRIPTION OF THE PREFERRED EMBODIMENTS

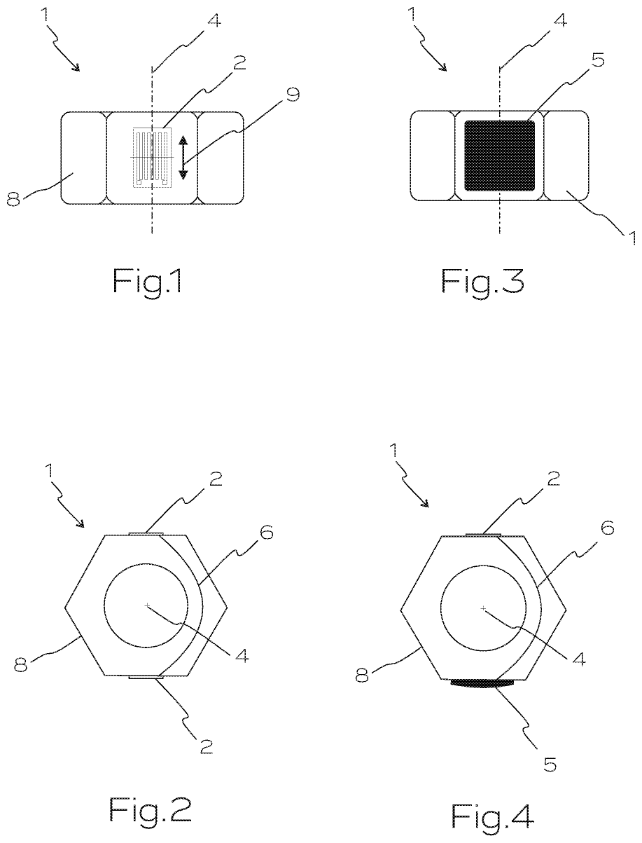

FIGS. 1 to 4 show schematic views of an inventive screw nut 1 according to a first example in different projection views, in lateral view (FIGS. 1 and 3) and in top and bottom view (FIGS. 2 and 4).

The screw nut 1 comprises two sensors 2, which are arranged on opposite lateral surfaces 8 of the screw nut 1 and are configured as strain gauges. The direction of measurement 9 of the strain gauges extends substantially parallel to the screwing axis/the screw axis 4 of the nut 1, which is substantially defined by the orientation of the internal threads of the nut 1.

The two sensors 2 are connected to one another via sensor cables so that the measurement signal can be read out via a single transmitter. The transmitter is configured as a passive RFID transponder 5 with an analog-to-digital converter and an amplifier. As a result, the measuring arrangement does not require a permanent power supply; instead, the energy required for measuring and reading out the measured value is supplied by an external readout device (not shown).

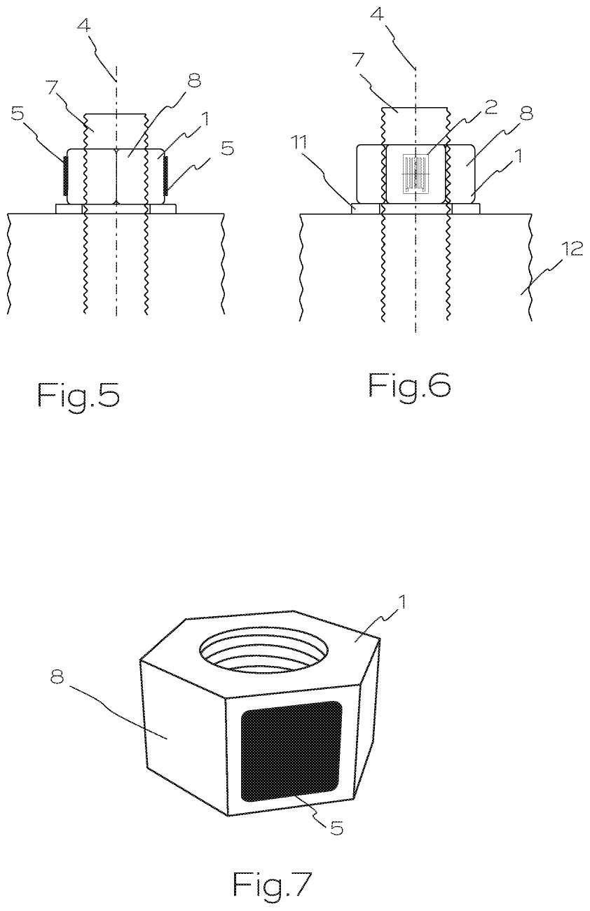

FIGS. 5 and 6 show schematic views of an inventive screw nut 1 according to a second example. The screw nut 1 is screwed on a threaded bolt 7 and, via a washer 11, presses against an element 12 to be fastened. The compression of the nut 1 is inversely proportional to the tensioning force. In contrast to the first example, this screw nut 1 comprises only one sensor 2 and two RFID transponders 5.

FIG. 7 shows a schematic perspective view of an inventive screw nut 1 according to a third example. On one lateral surface 8, an RFID transponder 5 is arranged; the sensor 2 is not shown.

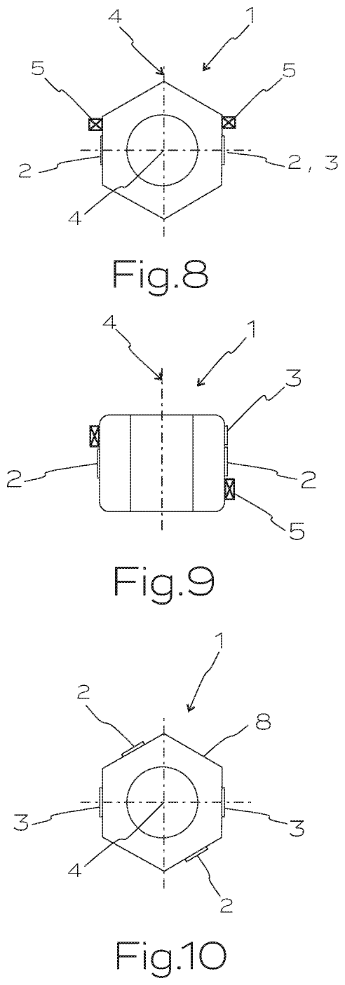

FIGS. 8 and 9 show schematic views of an inventive screw nut 1 according to a fourth example in top view (FIG. 8) and in lateral view (FIG. 9).

The screw nut 1 comprises two sensors 2, which are arranged on opposite lateral surfaces 8 of the screw nut 1 and are configured as strain gauges. Further, on one lateral surface 8 with a sensor 2 a further sensor 3 is provided, which is configured as a strain gauge. The direction of measurement 9 of the sensors 2 extends substantially parallel to the screwing axis/the screw axis 4 of the nut 1, while the direction of measurement 9 of the sensor 3 extends substantially transversely/orthogonally to the screwing axis/the screw axis 4 of the nut 1.

For transmitting the measured values, two RFID transponders 5 are provided.

Among other things, the sensor 3 serves to determine strains and compressions of the screw nut 1, which are not caused by a change of the tensioning force, but by temperature fluctuations, for example.

In an example which is not shown, the sensor 3 may be replaced by a temperature sensor, in order to determine temperature fluctuations and be able to determine the strain/compression of the screw nut 1 resulting therefrom.

FIG. 10 shows a schematic top view of an inventive screw nut 1 according to a fifth example. Here, two sensors 2 are provided, which are configured as strain gauges and the direction of measurement of which extends parallel to the screw axis 4. Further, two sensors 3 are provided, which are configured as strain gauges and the direction of measurement of which extends orthogonally to the screw axis 4. To simplify matters, the RFID transponder 5 and other elements are not shown.

### LIST OF REFERENCE SIGNS

1 Screw nut

2 Sensor

3 Sensor

4 Screw axis

5 RFID transponder/micro-controller

6 Sensor line

7 Threaded bolt/screw

8 Lateral surface

9 Direction of measurement

10 Screw

11 Washer

12 Element

1. An intelligent screw nut, wherein the screw nut comprises strain gauges configured to measure compression of the screw nut, wherein the strain gauges are fixed to at least one lateral surface.

2. The intelligent screw nut according to claim 1, characterized in that the screw nut is equipped with an RFID transponder or a micro-controller.

3. The intelligent screw nut according to claim 1, characterized in that the strain gauges are oriented in the direction of the screw axis and/or transversely to the screw axis.

4. The intelligent screw nut according to claim 1, characterized in that an RFID transponder or micro-controller is connected to the strain gauges sensors by means of a sensor cable.

5. The intelligent screw nut according to claim 1, characterized in that an RFID transponder or micro-controller is fixed to a lateral surface or multiple lateral surfaces of the screw nut.

6. The intelligent screw nut according to claim 1, characterized in that sensor measurement signals are transmitted from one lateral surface to another lateral surface of the screw nut by means of a sensor cable.

7. The intelligent screw nut according to claim 1, characterized in that sensor measurement signals are transmitted from one lateral surface to another lateral surface of the screw nut by means of radio technology.

8. The intelligent screw nut according to claim 1, characterized in that the strain gauges are glued or welded to the at least one lateral surface.

9. The intelligent screw nut according to claim 1, characterized in that the screw nut is equipped with an RFID transponder, wherein the RFID transponder comprises an analog-to-digital converter and an amplifier.

10. The intelligent screw nut according to claim 1, characterized in that the screw nut is equipped with the RFID transponder is a passive RFID transponder.

11. The intelligent screw nut according to claim 1, characterized in that the screw nut further comprises a temperature sensor.

12. The intelligent screw nut according to claim 11, characterized in that the temperature sensor is designed to measure the temperature of the screw nut.

13. The intelligent screw nut according to claim 2, characterized in that the RFID transponder or the micro-controller is designed to wirelessly transmit measurement signals of the strain gauges to a receiver.
